(19) United States
(12) Patent Application Publication
(10) Pub. No.: US 2014/0257937 A1
(43) Pub. Date: Sep. 11, 2014

(54) SYSTEMS AND METHODS FOR IMPLEMENTING COMPUTING DEVICE FEATURES BASED ON USER INTERACTION

(71) Applicant: TOSHIBA GLOBAL COMMERCE SOLUTIONS HOLDINGS CORPORATION, Research Triangle Park, NC (US)

(72) Inventors: David A. Bernath, Cary, NC (US); Jarrad A. Giles, Raleigh, NC (US); Brad M. Johnson, Raleigh, NC (US); Bradley T. Marchesseault, Cary, NC (US); Jeffrey J. Smith, Raleigh, NC (US)

(21) Appl. No.: 13/928,761

(22) Filed: Jun. 27, 2013

Related U.S. Application Data
(60) Provisional application No. 61/776,019, filed on Mar. 11, 2013.

(51) Int. Cl. G06Q 10/06

(52) U.S. Cl. CPC G06Q 10/0639
USPC 705/7.38

(57) ABSTRACT

Systems and methods for implementing computing device features based on user interaction are disclosed herein. According to an aspect, a method comprises using at least one processor and memory for determining a measure of interaction of a user at a computing device. The method also includes determining whether the measure meets a predetermined criterion. Further, the method includes implementing a feature set by the user in response to determining that the measure meets the predetermined criterion.

### CROSS REFERENCE TO RELATED APPLICATION

This application claims the benefit of U.S. Provisional Patent Application No. 61/776,019, filed Mar. 11, 2013 and titled SYSTEMS AND METHODS FOR IMPLEMENTING COMPUTING DEVICE FEATURES BASED ON USER INTERACTION, the content of which is hereby incorporated herein by reference in its entirety.

### TECHNICAL FIELD

The present invention relates to implementation of computing device features, and more specifically, to implementing features based on user interaction with a computing device.

### BACKGROUND

In retail environments, such as grocery stores and other “brick and mortar” stores, retail personnel often operate retail equipment such as point-of-sale (POS) equipment. At POS equipment, retail personnel may operate the equipment and interact with customers for conducting purchase transactions. Many retail equipment and systems are designed specifically for increasing sales throughput and increasing the speed of purchase transactions to meet the desire for increased productivity. Productivity may also be increased by improving the interface between the retail personnel and retail equipment in order to make the experience pleasing to the retail personnel. As a result, productivity of the retail personnel can be improved because their work experience is more satisfying. Accordingly, it is desired to provide improvements in the way that retail equipment interface with retail personnel.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for implementing computing device features based on user interaction. According to an aspect, a method comprises using at least one processor and memory for determining a measure of interaction of a user at a computing device. The method also includes determining whether the measure meets a predetermined criterion. Further, the method includes implementing a feature set by the user in response to determining that the measure meets the predetermined criterion.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system according to embodiments of the present invention;

FIG. 2 is a flowchart of an example method for implementing one or more features at a computing device in accordance with embodiments of the present invention; and

FIG. 3 is a screen display portion showing features that may be enabled in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

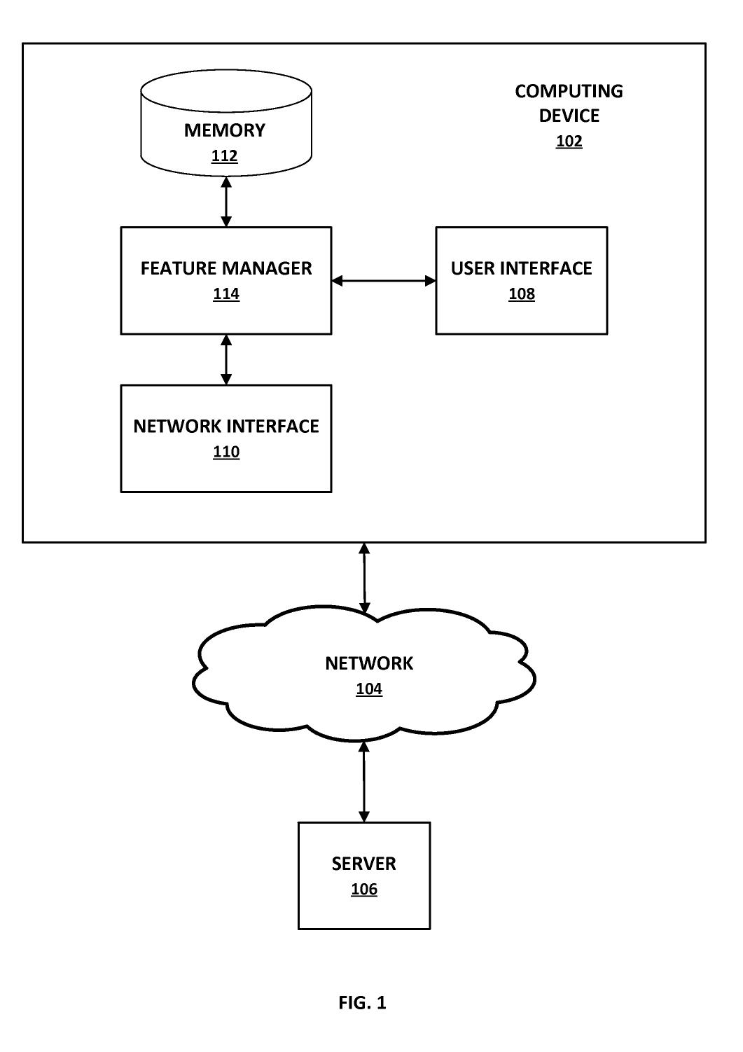

The presently disclosed invention is now described in more detail. For example, FIG. 1 illustrates a block diagram of a system 100 according to embodiments of the present invention. The system 100 may be implemented in whole or in part in any suitable environment for conducting purchase transactions. For example, the system 100 may be implemented in a retail store having a variety of products or items for purchase and one or more POS terminals. For example, a computing device 102 may operate as a POS terminal that can be operated by retail personnel for conducting purchase transactions with customers. The computing device 102 may be communicatively connected via a communications network 104, which may be any suitable local area network (LAN), either wireless and/or wired. The computing device 102 and other components, not shown, may be configured to acquire data within the retail environment, to process the data, and to communicate the data to a centralized server 106. Further, the server 106 may communicate data to the computing device 102 and other components of the system 100. The server 106 may reside in the retail store or be remotely located.

The components of the system 100 may each include hardware, software, firmware, or combinations thereof. For example, software residing in memory of a respective component may include instructions implemented by a processor for carrying out functions disclosed herein. As an example, the computing device 102 may each include a user interface 108 including a display (e.g., a touchscreen display), a barcode scanner, and/or other equipment for interfacing with retail personnel and for conducting a purchase transaction for purchase of items by customers. The computing device 102 may also include memory 112. The computing device 102 may be a self-checkout POS terminal or a retail personnel-assisted POS terminal. The computing device 102 may also include a suitable network interface 110 for communicating with the network 104. The computing device 102 may include hardware (e.g., image capture devices, scanners, and the like) for capture of various data within the retail environment. For example, the computing device 102 may include a scanner for scanning items and customer interface equipment for allowing customers to make purchases.

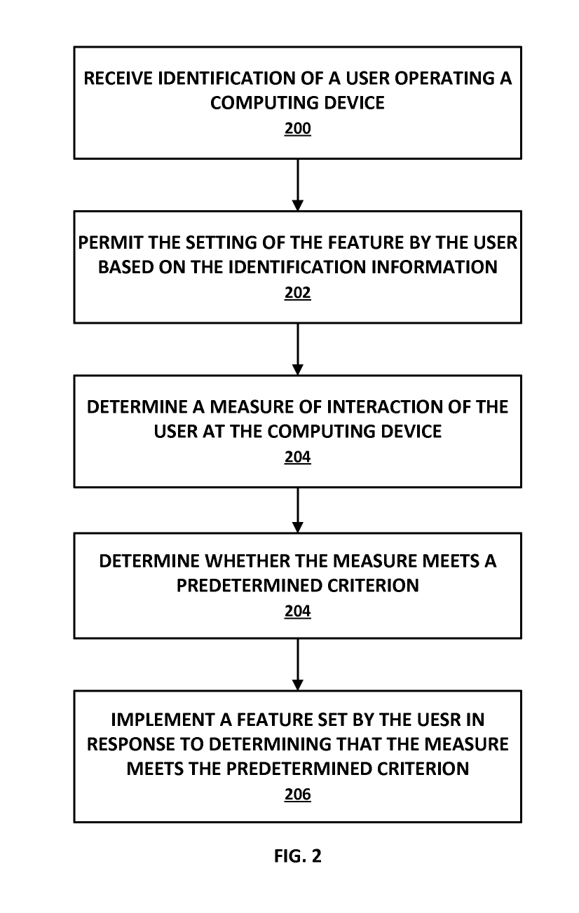

In accordance with embodiments of the present invention, features of a computing device may be implemented based on user interaction with the computing device. For example, features may be enabled on the computing device 102 may be enabled based productivity of retail personnel at the computing device 102. FIG. 2 illustrates a flowchart of an example method for implementing one or more features at a computing device in accordance with embodiments of the present invention. The method of FIG. 2 is described as being implemented by a feature manager 114 of the computing device 102, although the method may be implemented by any suitable computing device. The method may be implemented by hardware, software, and/or firmware of the computing device 102 and/or another computing device. For example, the memory 112 and a processor (not shown) of the computing device 102 may implement the method.

Referring to FIG. 2, receiving 200 identification information of a user operating the computing device. For example, retail personnel or operator of the computing device 100 shown in FIG. 1 may log into the system. The retail personnel may enter a login name and password, for example. In an example, a user may interact with the user interface 108 to enter the login name and password, or other credentials. The feature manager 114 may be provided with the identification information. Further, the identification information may be stored in memory 112.

The method of FIG. 2 includes permitting 202 the setting of a feature by the user based on the identification information. For example, the retail personnel may use the user interface 108 (e.g., a touchscreen display, keyboard, and/or mouse) to set a GUI customization. The feature manager 114 may control the user interface 108 for providing an interface for the user to set the feature. Subsequent to feature information being entered, the information may be provided to the feature manager 114. Different customizations may be allowed based on the identification information. For example, certain retail personnel of higher positions may be allowed to set customizations that the personnel of lower positions cannot set. In an example, retail personnel may be allowed to set a personal screensaver or screen background that can be enabled after the retail personnel has reached a certain level of performance. As a result, retail personnel are motivated to at least reach that level of performance. In addition, employee satisfaction may be increased when they are rewarded for achieving the performance level.

Other example features that can be set by a user include, but are not limited to, computer or GUI widgets. Example GUI widgets include sports score and information tickers, rich site summary (RSS) feeds, social networking feeds, and the like. Example features also include providing access to Internet content, providing access to personal content, providing access to entertainment content, providing access to gaming content, providing RSS feed content, providing a GUI feature, providing social networking content, and the like.

The method of FIG. 2 includes determining 204 a measure of interaction of a user at a computing device. The measure may be a measure of user productivity at the computing device 102. For example, retail personnel may operate the computing device 102 for conducting purchase transactions with customers. The feature manager 114 may determine one or more measures of the performance of the retail personnel. For example, the feature manager 114 may determine a number of purchase transactions conducted by retail personnel. The feature manager 114 may determine other sales-related measures or combinations of sales-related measures. Example measures can include, but art not limited to, items scanned per minute, add-on sales, transaction times, average waiting times, normalized transaction times, number of customers purchasing a particular item, number of customers purchasing insurance or warranties for a particular product, total sales over a particular time, total profit over a particular time, number of customers providing loyalty information, number of customers using a retailer's credit card, shopper feedback on the associate's performance delivered immediately or later/remotely, performance against expected performance for a particular time period, and the like. These measures may be collected, for example, through POS equipment.

The method of FIG. 2 includes determining 206 whether the measure meets a predetermined criterion. Continuing the aforementioned example, the feature manager 114 may determine whether the number of purchase transactions conducted by retail personnel meets a predetermined number within a predetermined time period. The determination may be made by comparing the measure to a predetermined criterion such as level or number of the measure.

The method of FIG. 2 includes implementing 208 a feature set by the user in response to determining that the measure meets the predetermined criterion. Continuing the aforementioned example, the feature manager 114 may implement a feature set by the user in response to determining that the retail personnel conducted the predetermined number of purchase transactions within the predetermined time period. In an example, if a predetermined number of purchase transactions have been achieved with a predetermined time period, the feature manager 114 may allow set RSS feeds and/or sports scores to be displayed on a display of the user interface 108.

In accordance with embodiments of the present invention, a user, such as retail personnel, may visualize his or her performance or productivity on a display of POS equipment. In an example, the computing device may determine measures or performance and present (e.g., display) a representation of the measure along with an indicator of how close he or she is to meeting predetermined criterion or threshold.

In accordance with embodiments of the present invention, rewards for retail personnel or other users may include, but are not limited to, freedom to visit certain webpages for a certain amount of time (e.g, FACEBOOK® social networking site), access to a second screen “panel” that includes the RSS feeds or sports scores (may be accessed by a swipe), personalized screen backgrounds or themes, access to certain webpages during busy times, and the like. In another example, a user may be provided access to webpages and the like on a different computing device, such as, but not limited to, the user's smartphone or table, a retailer-provided computing device (e.g., a tablet computer), and the like.

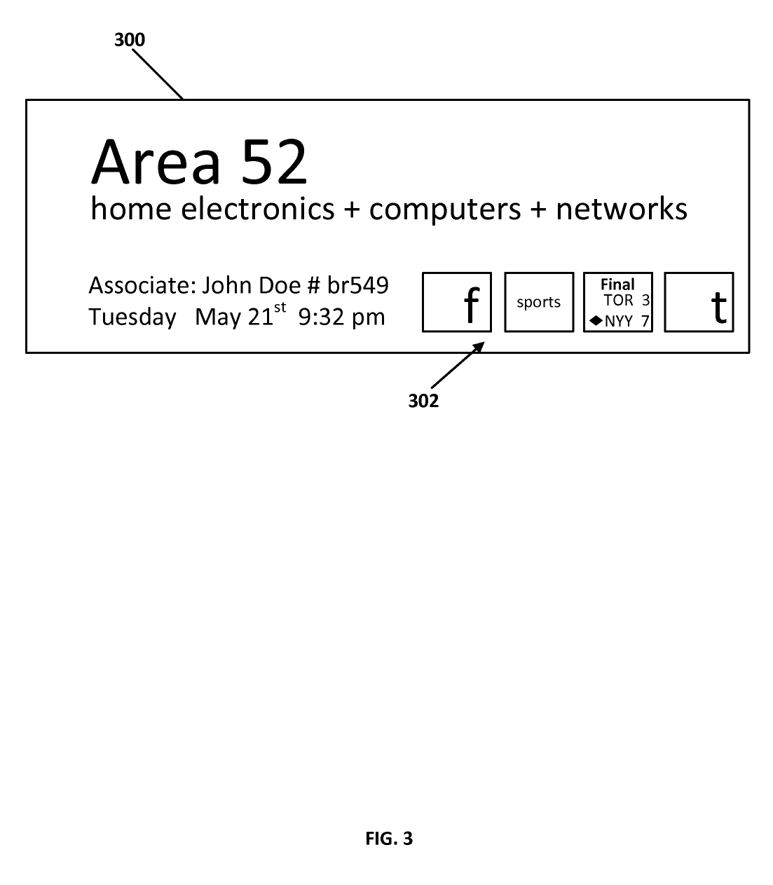

FIG. 3 illustrates a screen display portion 300 showing features 302 that may be enabled in accordance with embodiments of the present invention. Referring to FIG. 3, the screen display portion 300 shows information about a store area, retail associate, and current time/date. Further, the features 302 can be enabled for display when the retail associate meets predetermined criterion, such as a number of purchase transactions. The enabled features 302 include a FACEBOOK® display icon for accessing social networking content, a sports display icon (e.g., an ESPN® display icon) for accessing sports information, a sports score feed, and a TWITTER® display icon for accessing social networking content.

In accordance with embodiments of the present invention, the feature manager 114 may change the operation of the computing device 102 between a work mode and a user-selected feature mode. For example, in a work mode, the computing device 102 may operate for conducting purchase transactions. In a user-selected mode, the computing device 102 may display or permit user-selected features, such as the enabled features 302 shown in FIG. 3. Further, the feature manager 114 may determine a predetermined operation of the computing device 102 such as, for example, that the computing device 102 is being used for conducting a purchase transaction. In response to determining the predetermined operation, the feature manager 114 may disable the user-set feature such as, for example, the features 302 shown in FIG. 1. In another example, an operator of the computing device 102 may interact with the user interface 108 for instructing the feature manager 114 to switch between the work and user-selected feature modes.

In accordance with embodiments of the present invention, user-set features may be enabled for a predetermined time period. For example, the enabled features 302 shown in FIG. 3 may be enabled for a predetermined time period after a user has met a predetermined criterion or criteria. The features 302 may be disabled after the predetermined time period. Although the features 302 may be enabled again once the user has met predetermined criterion again, such as conducting a predetermined number of purchase transactions within a predetermined time period. In an example, the feature manager 114 may determine a predetermined operation of the computing device 102, and disable the feature set by the user in response to determining the predetermined operation.

An example advantage of embodiments of the present invention is that employee morale and job satisfaction can be improved by allowing certain features of a computing device, such as retail equipment, to be enabled at least temporarily. During a slow period of a work day at POS equipment for example, a user must stay at the POS equipment and may be unable to interact with the equipment to help the user relax. The user may be curious about his or her favorite sports team, for example. In this case, if he or she has met certain criterion, he or she may be allowed to view a game result for the team.

In an example scenario, the user at POS equipment may be allowed to see his or her set feature while conducting a purchase transaction as long as certain criterion, such as work performance, has been met. Rather than using his or her separate computing device and thereby being distracted from the POS equipment, he or she may be able to view desired content on the POS equipment. When a customer approaches to conduct a purchase transaction, the POS equipment user may interact with the equipment to cause the equipment to go to a work mode for conducting a purchase transaction.

In an example, when switching between a work mode and a user-selected feature mode, content for one or the other may fade to the background or be hidden when the user interacts with functions of the other mode. For example, POS functions may fade into the background of the display if a user is viewing or interacting with user-selected features. Similarly, user-selected features may fade into the background of the display if the user is operating the POS equipment in a work mode.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
using at least one processor and memory for:
determining a measure of interaction of a user at a computing device;
determining whether the measure meets a predetermined criterion; and
in response to determining that the measure meets the predetermined criterion, implementing a feature set by the user.

2. The method of claim 1, wherein the measure is a measure of user productivity at the computing device.

3. The method of claim 1, wherein the computing device is retail equipment.

4. The method of claim 1, wherein the computing device is point-of-sale (POS) equipment.

5. The method of claim 1, wherein determining a measure of interaction of a user comprises determining a measure of productivity at retail equipment, and
wherein implementing a feature comprises one or more of providing access to Internet content, providing access to personal content, providing access to entertainment content, providing access to gaming content, providing rich site summary (RSS) feed content, providing a graphical user interface (GUI) feature, and providing social networking content.

6. The method of claim 1, further comprising:
determining a predetermined operation of the computing device; and
in response to determining the predetermined operation, disabling the feature by the user.

7. The method of claim 1, further comprising:
determining a time period for enabling the feature; and
enabling the feature for the time period.

8. The method of claim 1, further comprising receiving user input for setting the feature.

9. The method of claim 1, further comprising:
receiving identification information of a user operating the computing device; and
permitting the setting of the feature by the user based on the identification information.

10. A system comprising:
at least one processor and memory;
a feature manager configured to:
determine a measure of interaction of a user at a computing device;
determine whether the measure meets a predetermined criterion; and
implement a feature set by the user in response to determining that the measure meets the predetermined criterion.

11. The system of claim 10, wherein the measure is a measure of user productivity at a computing device.

12. The system of claim 11, wherein the computing device is retail equipment.

13. The system of claim 11, wherein the computing device is point-of-sale (POS) equipment.

14. The system of claim 10, wherein the measure of interaction of a user comprises a measure of productivity at retail equipment, and
wherein the feature comprises one or more of providing access to Internet content at a computing device, providing access to personal content at a computing device, providing access to entertainment content at a computing device, providing access to gaming content at a computing device, providing rich site summary (RSS) feed content at a computing device, providing a graphical user interface (GUI) feature at a computing device, and providing social networking content at a computing device.

15. The system of claim 10, wherein the feature manager is configured to:
determine a predetermined operation of a computing device; and
disable the feature by the user in response to determining the predetermined operation.

16. The system of claim 10, wherein the feature manager is configured to:
determine a time period for enabling the feature; and
enable the feature for the time period.

17. The system of claim 10, wherein the feature manager is configured to receive user input for setting the feature.

18. The system of claim 10, wherein the feature manager is configured to:
receive identification information of a user operating the computing device; and
permit the setting of the feature by the user based on the identification information.

19. A computer program product for implementing a feature at a computing device, said computer program product comprising:
a computer readable storage medium having computer readable program code embodied therewith, the computer readable program code comprising:
computer readable program code configured to determine a measure of interaction of a user at a computing device;
computer readable program code configured to determine whether the measure meets a predetermined criterion; and
computer readable program code configured to implement a feature set by the user in response to determining that the measure meets the predetermined criterion.

20. The computer program product of claim 19, wherein the measure is a measure of user productivity at a computing device.

21. The computer program product of claim 20, wherein the computing device is retail equipment.

22. The computer program product of claim 20, wherein the computing device is point-of-sale (POS) equipment.

23. The computer program product of claim 19, wherein the measure of interaction of a user comprises a measure of productivity at retail equipment, and
wherein the feature comprises one or more of providing access to Internet content at a computing device, providing access to personal content at a computing device, providing access to entertainment content at a computing device, providing access to gaming content at a computing device, providing rich site summary (RSS) feed content at a computing device, providing a graphical user interface (GUI) feature at a computing device, and providing social networking content at a computing device.

24. The computer program product of claim 19, further comprising:
determine a predetermined operation of a computing device; and
disable the feature by the user in response to determining the predetermined operation.

25. The computer program product of claim 19, further comprising:
computer readable program code configured to determine a time period for enabling the feature; and
computer readable program code configured to enable the feature for the time period.

26. The computer program product of claim 19, further comprising computer readable program code configured to receive user input for setting the feature.

27. The computer program product of claim 19, further comprising computer readable program code configured to:
receive identification information of a user operating the computing device; and
permit the setting of the feature by the user based on the identification information.
